(19) United States
(12) Patent Application Publication
(10) Pub. No.: US 2007/0164587 A1
(43) Pub. Date: Jul. 19, 2007

(54) Roof structure for a multi-purpose vehicle

(76) Inventor: Franz Ulrich Brockhoff, Bramsche (DE)

Correspondence Address: Mark A Ussal;Michael Best & Friedrich, Suite 3300, 100 East Wisconsin Avenue, Milwaukee, WI, 53202-4108, US

(21) Appl. No.: 10/589,549

(22) PCT Filed: Feb. 10, 2005
(86) PCT No.: PCT/DE05/00226

§ 371 Date: Aug. 16, 2006

(30) Foreign Application Priority Data
Feb. 17, 2004 (DE) 10 2004 007 587.5

(51) Int. Cl. B60J 7/11

(52) U.S. Cl. 296/218

(57) ABSTRACT

A roof structure (20) for a vehicle (10) comprises a rear roof part (24), which comprises a vehicle rear window (26), side, rear pillars (27) and a rear segment (25) of the vehicle roof and is displaceably borne in the vehicle longitudinal direction (B). In addition, a forward roof part (22) is provided that is attachable adjacent to a windshield frame (11) of the vehicle and is removable from the roof structure (20); its length in the vehicle longitudinal direction corresponds to the displacement path of the rear roof part (24). Lastly, the roof structure (20) comprises rear, side elements (28), which are attachable adjacent to the rear roof part (24) and are removable from the roof structure (20); their length in the vehicle longitudinal direction corresponds to the displacement path of the rear roof part.

The invention concerns a so-called multi-purpose vehicle (MPV) and in particular a roof structure for such a vehicle. By the term multi-purpose vehicle, it is understood that a vehicle can be modified into vehicles of different types and utilized, e.g., as a closed four-seater, a Targa four-seater, a pick-up or a convertible.

Vehicles that can be converted into two different vehicle types by converting its roof structure are known in the prior art.

For example, DE 40 38 873 A1 describes a convertible top for a vehicle, in which a rigid rear window (hard top) made of glass can be lowered into the luggage space of the vehicle. For this purpose, the structure between the rear window and the roof part includes a hinge region, with which the roof part can be folded onto the rear window. Moreover, on the lower end of the rear window (viewed in the assembled state of the vehicle), the assembly of the roof part and the rear window can pivot about a rotational axis that extends generally perpendicular to the vehicle longitudinal axis. By suitably folding together and pivoting about this axis, the assembly of the roof part and the rear part can be laid together flat and stored in the luggage space; thereafter, the trunk lid is pivoted thereon. Instead of pivoting the trunk lid for loading the assembly, a sliding mechanism is mentioned, with the assistance of which the pivot axis of the rear window can be displaced in the vehicle longitudinal direction and subsequently, the roof structure can be pushed under the trunk lid.

DE 26 47 236 A concerns a motor vehicle that can be converted from a closed vehicle with a hard top into a Targa-vehicle. To achieve this purpose, a displaceable roof part, which closes the area between the windshield frame and the trunk lid in its first position, is displaceable into a second position in the longitudinal direction of the vehicle; in this position, the roof part is disposed farther to the rear side and the area over the front row of seats of the vehicle is open. Further, the assembly has a rear window that can be raised and lowered by cranking.

A modifiable motor vehicle is known from DE 36 06 759 A, which vehicle includes a rearwardly opening passenger compartment with a roof covering the area of the front row of seats and has different structural units for the remaining rear area. A structural unit is provided in the form of a pivotable roof element, which is rigidly connectable with the base vehicle, and a likewise pivotable rear covering, which is connectable with the base vehicle, wherein the roof element is downwardly pivotable into the space underneath the rear area covering. As a result, the vehicle can be converted into a pick-up version, a convertible and/or a sedan configuration or a closed hard top, wherein the area of the front seats always remains covered by a roof.

A sports utility vehicle is known from US 2002-0079718 A1. The vehicle has a passenger compartment, and includes an immovable roof segment as well as a modifiable roof segment. The immovable roof segment is located essentially over the front seats of the vehicle; the modifiable roof segment is positioned rearward of the immovable roof segment. The modifiable roof segment comprises a flexible fabric skin as the cover and a mechanism that is telescopically extendable and contractable, respectively. A frame is affixed to this mechanism, whereby the flexible covering is tensioned between the frame and the front roof segment and the frame can be displaced in the vehicle longitudinal direction into its longitudinal position.

A motor vehicle with a convertible passenger compartment is known from DE 100 28 781 A1; the passenger compartment is formed from a front fixed segment that includes a vehicle roof and a rear, movable window module. The window module is displaceably borne on the chassis and has the function of varying the size of the passenger compartment relative to the fixed segment. Thus, in order to adjust the desired size of the passenger compartment, the window module borne on the chassis is simply displaced in the vehicle longitudinal direction. The front, chassis-affixed section of the passenger compartment, inclusive of the vehicle roof, remains unchanged. The front fixed section comprises, e.g., a driver's cabin with driver's seat and passenger's seat, such as e.g. for a pick-up or a small transporter with a loading surface, or a vehicle interior of a two- or four-door motor vehicle with one or two rows of seats. The window module is slidable into the front fixed section. Side windows of the window module are removable and re-installable.

Finally, a vehicle is known from DE 198 43 786 A1 that serves in particular as a two-or four-seat convertible vehicle. The vehicle includes a front roof area that is designed as a rigid component and a sunroof is integrated therein in order to open the front roof area. A caisson overlapping the two rear seats connects to this fixed roof area on the rear side thereof, which caisson is displaceable in the vehicle longitudinal direction, so that the passenger space can be reduced. In order to use the vehicle as a four-seat convertible vehicle, this rear area of the roof can also pivot and can be accommodated within the vehicle when the rear seat is folded down or behind the rear seat.

It is an object of the invention to provide a vehicle that can be utilized as a closed four-seater, a Targa four-seater, a pick-up or a two-seat convertible by means of a simple modification. In particular, it is an object to provide a roof structure for such a vehicle.

This object is solved by a roof structure with the features of claim 1 and/or a vehicle with the features of claim 5.

Preferred embodiments are specified in the dependent claims.

The concept underlying the invention is to modify a roof structure having a displaceable rear area, such that the roof structure is further modifiable for displacement of a part of the roof structure relative to the vehicle by taking out elements, which are disposed forward of the rear area with respect to the forward driving direction of the vehicle, from the roof structure. At the same time, the removable elements of the roof structure are adapted to the shape and size of the rear area as well as to the displacement path; as a result, by omitting the removable elements, a closed passenger space can be created when the elements are taken out and the rear area is displaced in the direction towards the front area of the vehicle. By the combination of elements that are detachable and removable from the roof structure with the displaceable rear roof part, the vehicle can be variously reconfigured, i.e. as a closed four-seat vehicle, a Targa vehicle, a pick-up vehicle as well as a convertible vehicle. The removable parts, i.e. the forward roof part as well as the rear, side elements, can be e.g. manually and completely removed from the roof and according to a preferred embodiment can be placed into a receptacle provided in the vehicle therefor. In the alternative, the two rear, side elements could be, e.g., manually or electronically driven and lowerable into the chassis side parts of the vehicle.

The terms “forward” and/or “front” respectively denote the part of the vehicle and/or roof that lies forwardly in the vehicle forward driving direction; “rear” and/or “rearward part” denote the corresponding part of the roof that lies rearward in the vehicle forward driving direction. Moreover, by “longitudinal plane” or “longitudinal direction,” respectively, the respective plane or direction is to be understood as lying parallel to the driving direction when driving straight in the vehicle forward direction.

In the following, the invention will be described in an exemplary manner with the aid of the appended figures, in which:

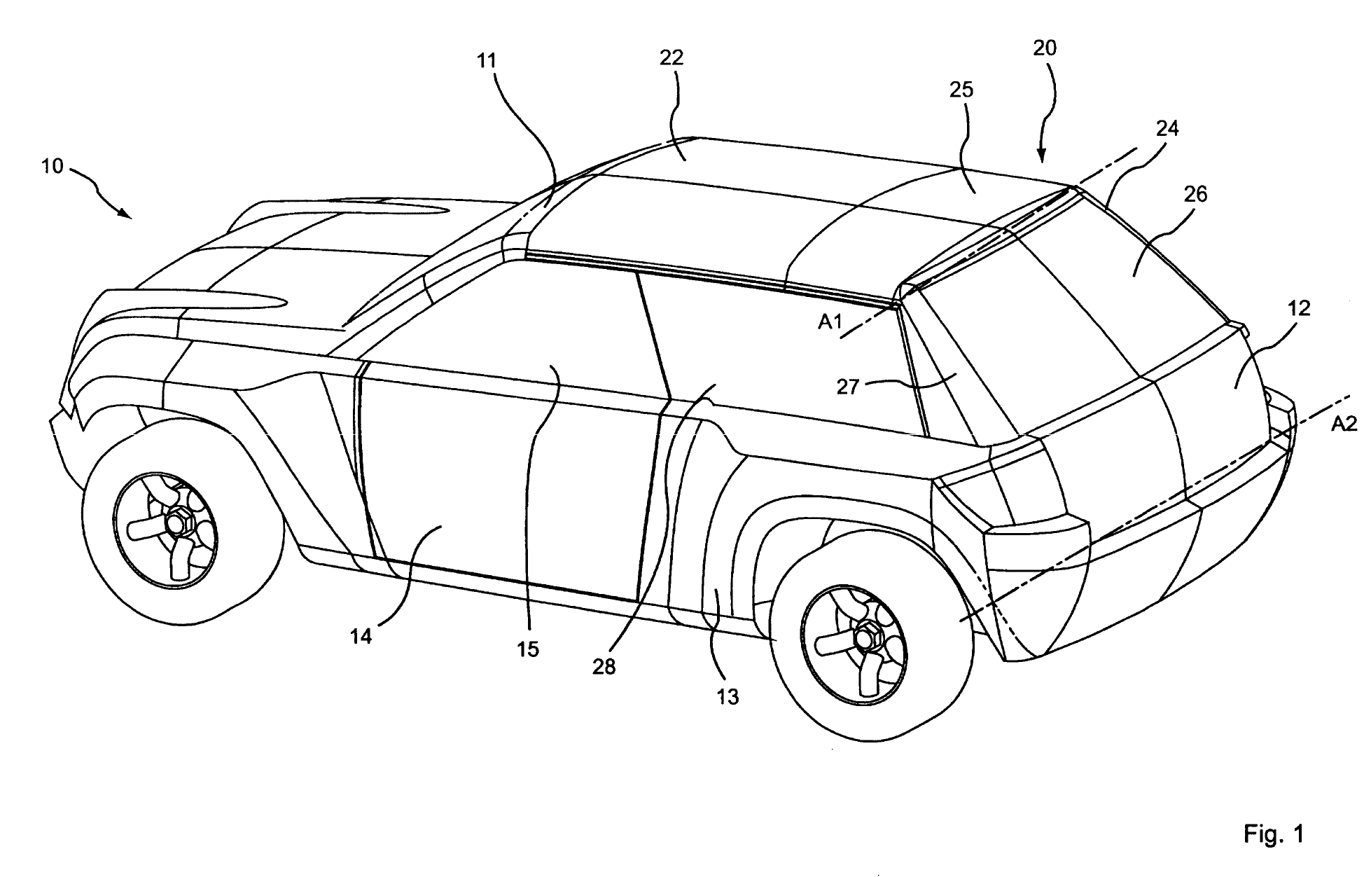

FIG. 1 shows a vehicle having an inventive roof structure, wherein the roof structure is closed such that the vehicle constitutes a closed four-seater;

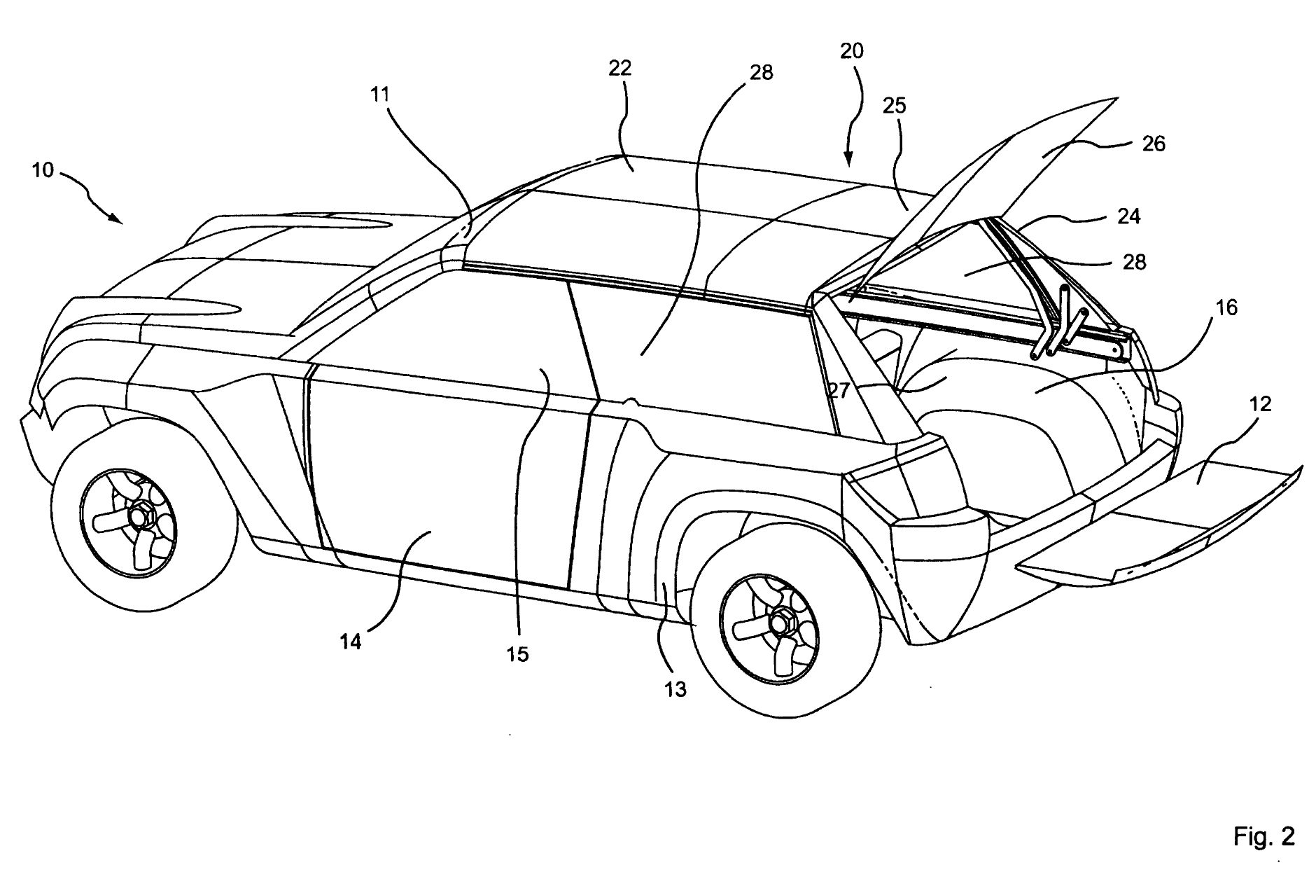

FIG. 2 shows the vehicle of FIG. 1 with an opened luggage space;

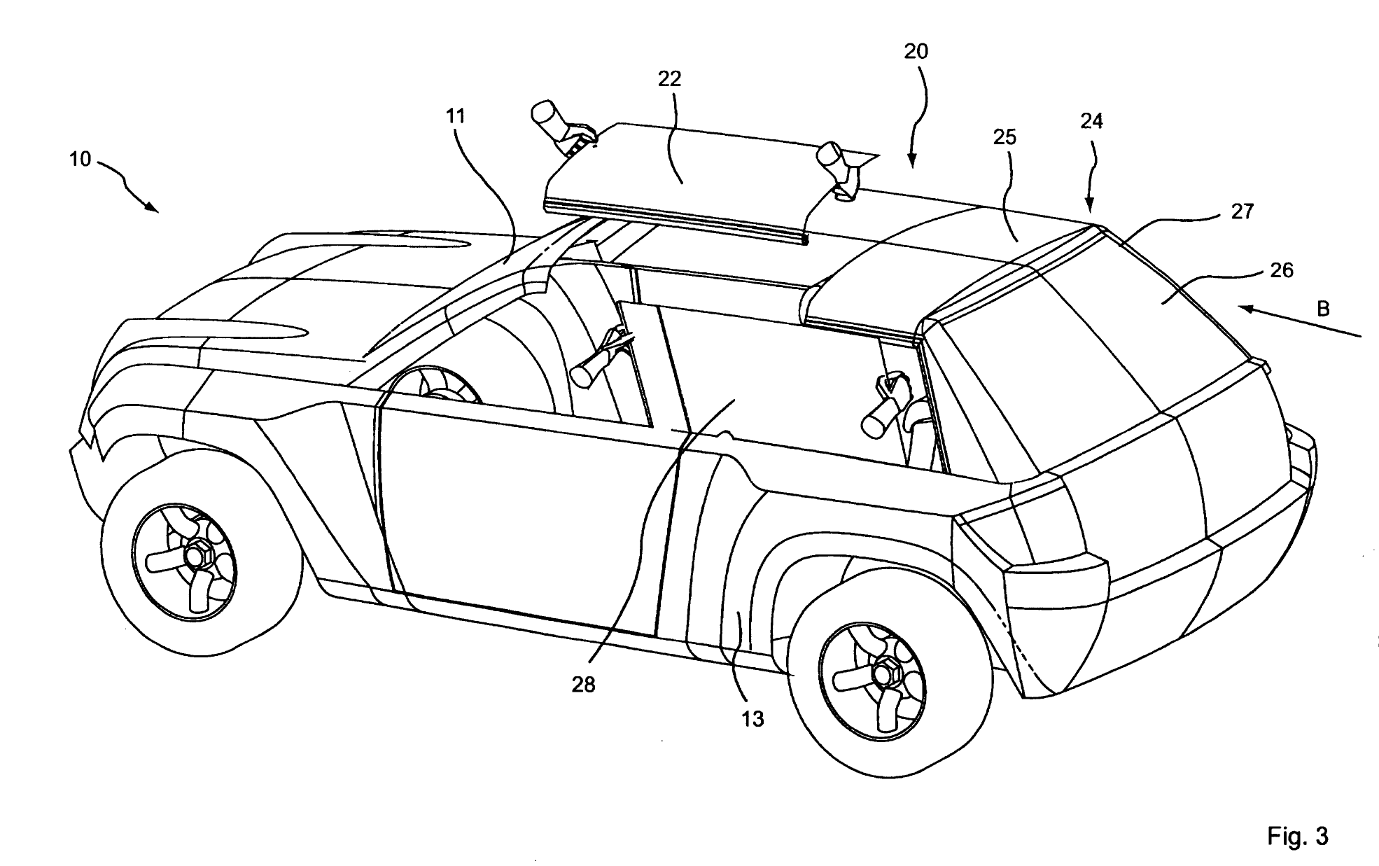

FIG. 3 shows the vehicle of FIG. 1, wherein removable roof parts are removed from the roof structure;

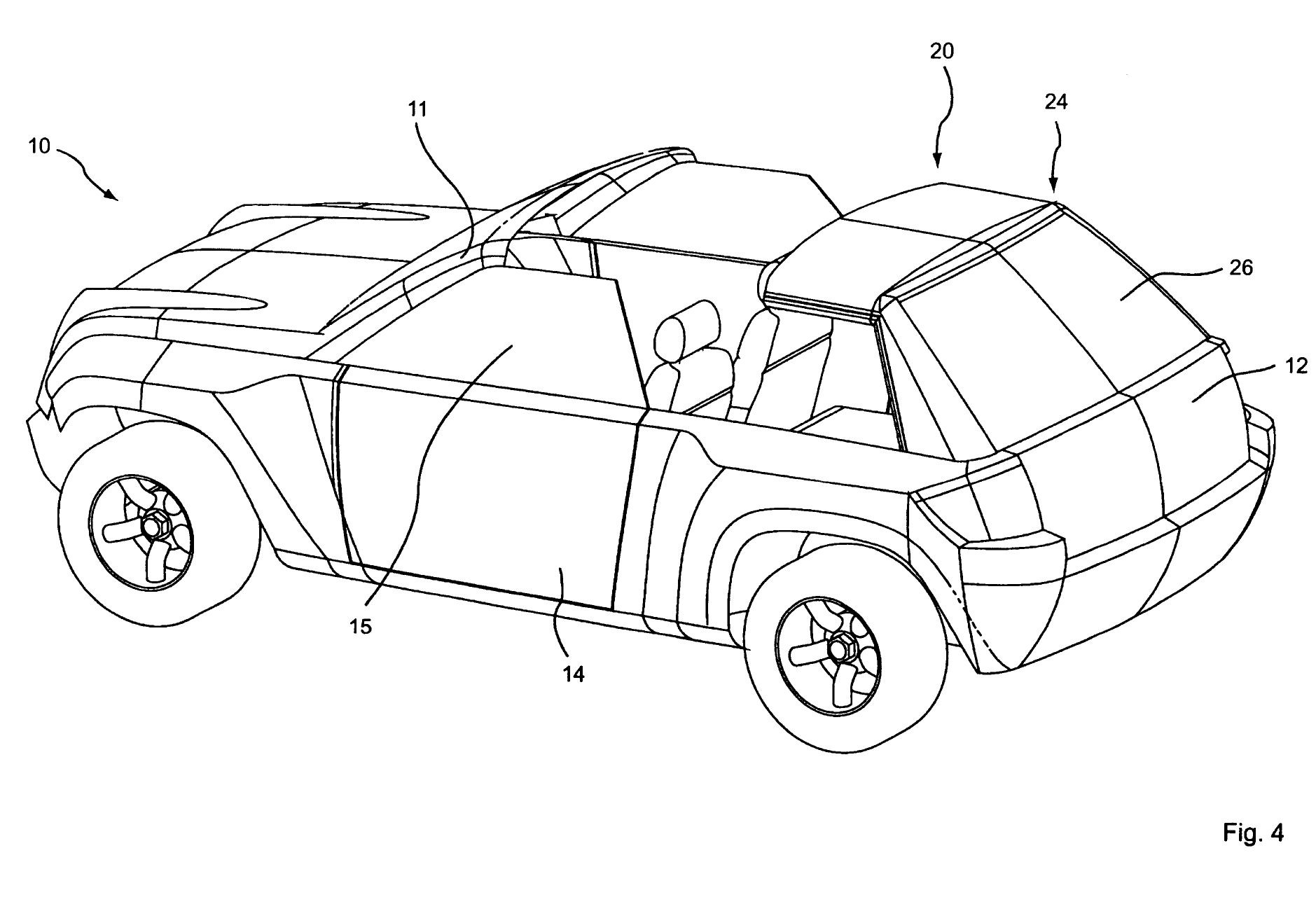

FIG. 4 shows the vehicle of FIG. 1, wherein the removable roof structure elements are removed;

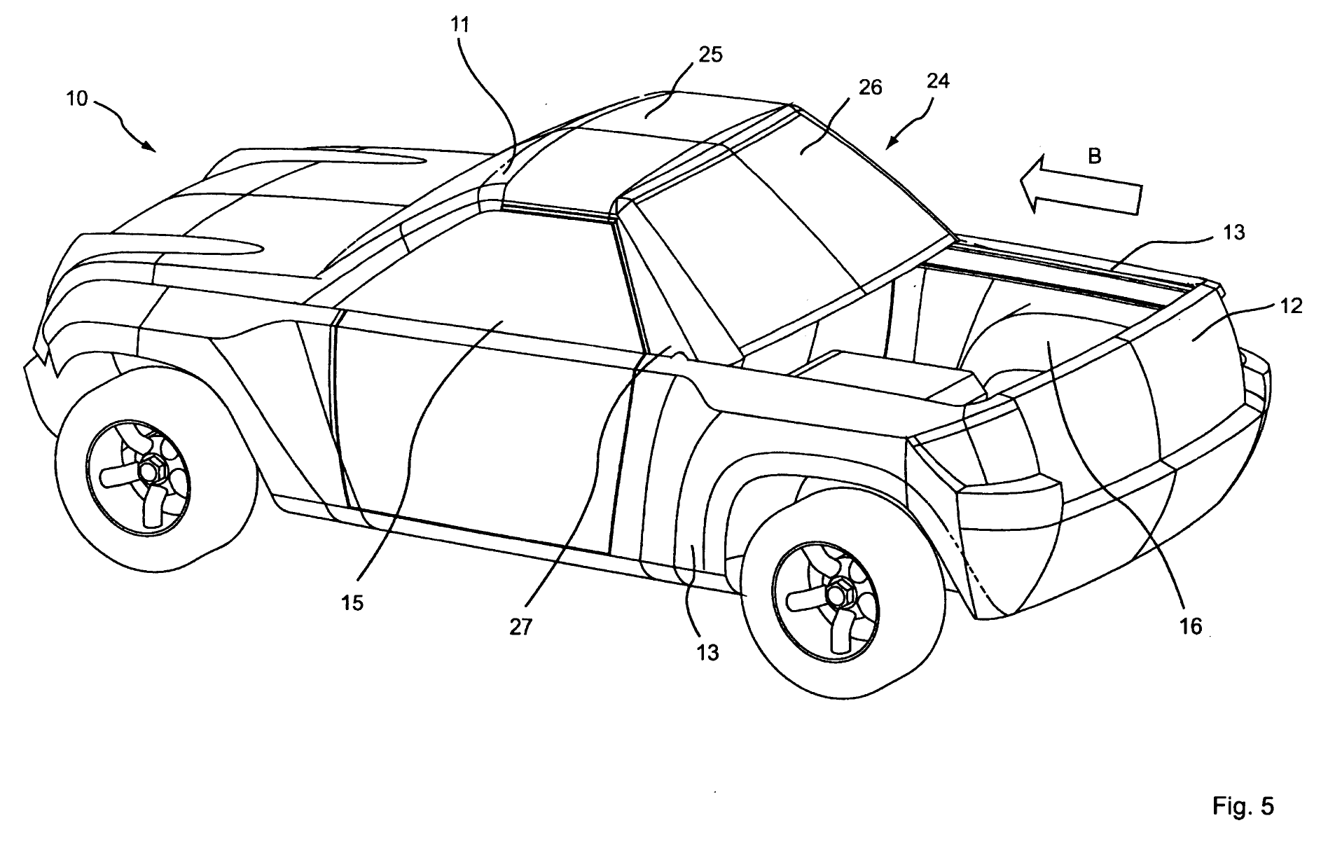

FIG. 5 shows the vehicle of FIG. 1, wherein the rear roof part is forwardly displaced so that a closed two-seater in a pick-up version is formed; and

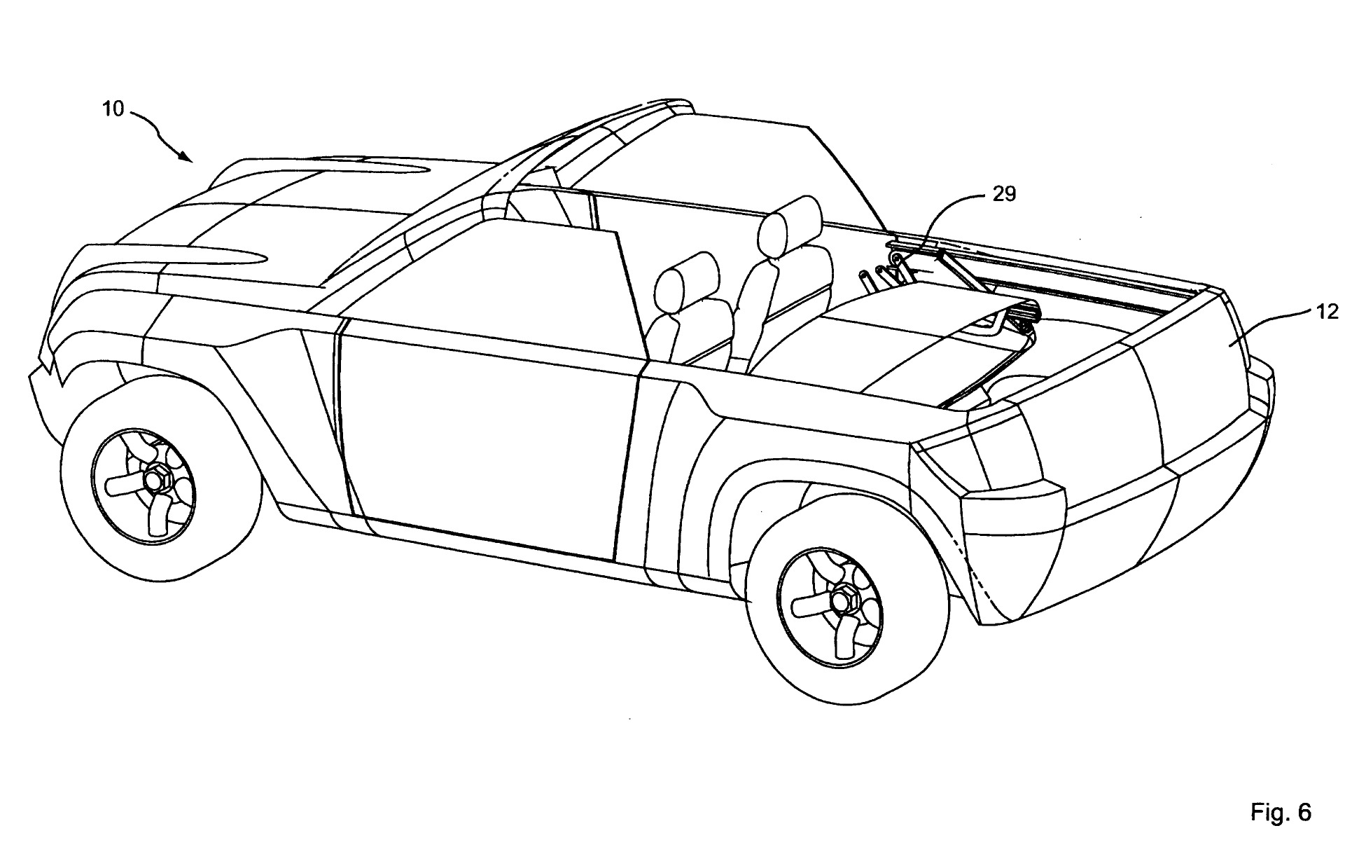

FIG. 6 shows the vehicle of FIG. 1, wherein the rear roof part is folded into the rear of the vehicle so that an open two-seater is formed.

FIG. 1 shows the vehicle 10, on which the inventive roof structure 20 is attached, in a state in which it is used as a closed four-seater. The inventive vehicle roof structure 20 comprises a forward roof part 22 that is situated adjacent to a windshield frame 11 of the motor vehicle. In the illustrated embodiment, the forward roof part 22 is two-part, i.e. it is divided along the central longitudinal plane of the vehicle. However, the forward roof part 22 can also be designed as a multi-part or as one-piece or it can include additional components, such as e.g. a sun roof or the like.

The rear roof part 24 is adjacent to the rear side of the forward roof part 22 in the assembled state of the vehicle 10. The rearward roof part 24 comprises a rear segment 25 of the vehicle roof that is disposed directly adjacent to the forward roof part and generally extends over the area of the rear seat bench of the vehicle and/or the hat rack when it is in the first position shown in FIG. 1. The design of the rear segment 25 of the vehicle roof and the forward roof part 22, which generally extends over the front seat area of the vehicle compartment in the assembled state, are selected such that, in the assembled state shown in FIG. 1, they abut each other along their terminal edges substantially without overlapping and form a closed roof structure.

The rear roof part 24 further comprises a vehicle rear window 26 that is disposed rearward of the rear segment 25 in the forward driving direction of the vehicle and comprises a corresponding frame 27. The rear window 26 is upwardly pivotable about an axis A1 that is denoted in FIG. 1 with a dashed line and extends generally perpendicular to the middle plane of the vehicle in the connection area between the rear segment 25 of the vehicle roof and the rear window 26. The upwardly pivoted state of the rear window 26 is illustrated in FIG. 2.

A rear part 12 of the vehicle 10 closes the rear, lower side of the rear window 26; the rear part 12 forms the rearward closure of the vehicle chassis. This rear part 12 is likewise outwardly pivotable in the illustrated embodiment, namely downwardly about an axis A2 that extends generally parallel to the axis A1 (see FIG. 2). In the opened state of the rear part 12 and the rear window 26 illustrated in FIG. 2, the luggage space is readily accessible when utilizing the vehicle 10 as a four-seat vehicle. For actuating the pivotable movement, mechanically- or electronically-assisted opening mechanisms are provided for the rear window 26 and the rear part 12.

The vehicle roof structure 20 further comprises two side elements 28, of which only one is visible in FIG. 1 due to the perspective illustration. The side elements 28 could be designed as window-like, i.e. transparent. It is, however, also possible according to the requirements of the vehicle to form them from the same material as the vehicle frame construction and more particularly, non-transparent. The side elements 28 are generally disposed between a rear-side, lateral chassis area 13 of the vehicle 10, the frame 27 of the rear window 26, the rear segment 25 of the vehicle roof, a part of the forward roof part 22 as well as a window 15 of the vehicle 10 mounted on the driver's door and/or the passenger's door 14.

The frame 27 for the rear window 26 is generally comprised of the two side, rear pillars that are each disposed between the rear window 26 and the rear, side element 28 of the roof structure 20.

In the first position of the roof structure shown in FIGS. 1 and 2, the removable forward roof part 22 and the removable side elements 28 are in the described assembled state in the roof structure. Therefore, a closed roof structure for the vehicle 10 is formed that covers and closes a passenger compartment with front and rear seat benches. Moreover, in this position, a luggage space for the closed four-seat vehicle is formed.

Access to the luggage space 16 of the vehicle 10 can be achieved by downwardly folding the rear part 12 and/or by upwardly folding the vehicle rear window 26 at the same time.

The four-seat vehicle 10 illustrated in FIGS. 1 and 2 is modifiable into a similar four-seat Targa vehicle that is illustrated in FIGS. 3 and 4. For this purpose, the forward roof part 22, if necessary all forward roof parts when the forward roof part 22 has a multi-part design, as well as the rear, side elements 28, are taken out of the roof structure.

The elements 22 and 28 are, for example, manually taken out of the vehicle (FIG. 3). In FIG. 4, the MPV, which has been modified into a Targa vehicle, is shown. In the alternative to manual removal of the elements 22, 28, the side, rear elements 28 could be e.g. lowered manually or by electrical-actuation into the rear-side, lateral chassis area 13.

Preferably, retention devices (not shown) are provided in the vehicle for the manually-removed, rear, side elements 28 as well as the forward roof part 22, so that the individual parts are securely stowed when they are not in their positions integrated in the roof structure. The rear roof part 24 remains in its first, rear-side position when the vehicle 10 is used as a Targa vehicle.

In the illustrated embodiment of the vehicle and in particular the roof structure 20, all elements are designed as rigid components (hard top). One part or all of the elements could be replaced with flexible materials, e.g. fabric or the like, that are tensioned on rigid elements.

Starting from the Targa version of the vehicle illustrated in FIGS. 3 and 4, the vehicle can be further modified into a pick-up vehicle using the inventive roof structure 20. In doing so, the forward roof part 22 and the rear, side elements 28 remain removed from the roof structure. For modifying the vehicle 10 into a pick-up vehicle (FIG. 5), the rear roof part 24 is displaced in the vehicle longitudinal direction, which is indicated by arrow B in FIG. 5, towards the front direction of the vehicle 10. For this purpose, appropriate guide rails or the like for the rear roof part 24 are mounted on the vehicle chassis, in particular on the rear-side, lateral chassis area 13 of the vehicle.

The displacement path, i.e. the distance that the rear roof part 24 is displaced along the vehicle chassis in the direction of arrow B, corresponds in the vehicle longitudinal direction to the length of the side elements 28 and the forward roof part 22. Moreover, the contours of the rear segment 25 of the vehicle roof as well as its lateral contours, which are directed towards the front of the vehicle, are adapted to the shape and dimension of the windshield frame 11 (upper edge) and/or the driver- or passenger-door having the window 15 provided therein. The contours of the frame 27, i.e. in particular the lateral, rear pillars, are adapted to the shape and dimension of the driver- and/or passenger-door (rear-side edge). Consequently, the rear roof part 24 together with these elements forms a closed passenger compartment, in which the two front seats are located when the roof structure is in the position displaced towards the front.

The rear area of the vehicle is open so that an open loading surface 16, where the luggage space area is located when the four-seat vehicle is closed, is formed there. By folding down and removing the rear seat bench, this loading space can be further enlarged. Because the rear part 12 of the vehicle 10 can be downwardly pivoted about the axis A2, loading of the loading space 16 is also possible without problems in the pick-up version.

A separating wall, which is e.g. foldable or pluggable into a retainer, is preferably provided in order to seal the passenger compartment; the separating wall is brought into the area between the lower edge of the rear window frame and the floor of the loading surface when the vehicle is in the pick-up version and consequently, the loading surface is separated from the passenger compartment in a water-proof manner. For example, the separating wall can be formed by the front roof part 22 or one or more elements formed thereon.

Lastly, the vehicle can be used as a two-seat, open convertible vehicle (see FIG. 6). For this purpose, starting from the pick-up version illustrated in FIG. 5, the rear roof part 24 is stored in the rear area of the vehicle, i.e. the area behind the front seats, by means of an actuating mechanism, e.g., a linkage mechanism 29. For this purpose, the rear segment 25 of the vehicle roof and the rear window 26 with the frame 27 are stored on top of each other by pivoting them relative to each other about the axis A1. In this folded state, they are loaded into the interior of the vehicle by being driven by a motor or by hand.

Consequently, by the combination of removable components, namely the forward roof part 22 and the rear, side elements 28, and the displaceable rear roof part 24, which is also pivotable into the rear space of the vehicle, the vehicle 10 can be utilized in various ways, namely as a closed four-seat vehicle, a Targa vehicle, a pick-up vehicle as well as an open, two-seat vehicle.

### REFERENCE NUMBERS

10 vehicle
11 windshield
12 rear part
13 rear-side, lateral chassis area
14 driver's door/passenger's door
15 window in driver's door/passenger's door
16 luggage space
20 roof structure
22 forward roof part
24 rearward roof part
25 rear segment of the vehicle roof
26 vehicle rear window
27 frame
28 side elements
39 [sic, 29] linkage mechanism
A1 axis
A2 axis

1-9. (canceled)

10. A roof structure for a vehicle, comprising:
a rear roof part arranged and constructed so as to be displaceable in a longitudinal direction of the vehicle along a displacement path on a chassis of the vehicle, the rear roof part including:
a rear window,
rear pillars respectively disposed on lateral sides of the rear window, and
a rear segment coupled to the rear window and the rear pillars,
a forward roof part arranged and constructed so as to be attachable adjacent to a windshield frame of the vehicle and to be detachable from the roof structure, the forward roof part having a length in the vehicle longitudinal direction that substantially corresponds to the length of the displacement path of the rear roof part, and
rear, side elements arranged and constructed to be attachable adjacent to the rear roof part and to be detachable from the roof structure, the rear, side elements having a length in the vehicle longitudinal direction that corresponds to the length of the displacement path of the rear roof part.

11. A roof structure according to claim 10, wherein at least one of the forward roof part and the rear, side elements is manually detachable.

12. A roof structure according to claim 11, wherein the rear window is upwardly pivotable about an axis that extends substantially perpendicular to a longitudinal plane of the vehicle.

13. A roof structure according to claim 12, wherein the forward roof part, as well as the rear window, the rear pillars and the rear segment of the rear roof part, are rigid structures.

14. A roof structure according to claim 13, wherein contours of the rear pillars that face towards a front of the vehicle and contours of the rear segment that face towards a side of the vehicle respectively correspond to upper and rear contours of a window of a side vehicle door.

15. A roof structure according to claim 10, wherein the rear window is upwardly pivotable about an axis that extends substantially perpendicular to a longitudinal plane of the vehicle.

16. A roof structure according to claim 10, wherein the forward roof part, as well as the rear window, the rear pillars and the rear segment of the rear roof part, are rigid structures.

17. A roof structure according to claim 10, wherein contours of the rear pillars that face towards a front of the vehicle and contours of the rear segment that face towards a side of the vehicle respectively correspond to upper and rear contours of a window of a side vehicle door.

18. A roof structure according to claim 10, wherein the rear, side elements each comprise a transparent, removable panel.

19. A vehicle, comprising:
a chassis,
a windshield frame supported by the chassis, and
a roof structure comprising:
a rear roof part displaceable in a longitudinal direction of the vehicle along a displacement path on the chassis, the rear roof part having:
a rear window,
rear pillars respectively disposed on sides of the rear window, and
a rear segment,
a forward roof part removably attachable adjacent to the windshield frame and detachable from the roof structure, the forward roof part having a length in the vehicle longitudinal direction that substantially corresponds to the length of the displacement path of the rear roof part, and
rear, side elements removably attachable adjacent to the rear roof part and detachable from the roof structure, the rear, side elements having a length in the vehicle longitudinal direction that substantially corresponds to the length of the displacement path of the rear roof part.

20. A vehicle according to claim 19, further comprising a rear part of the vehicle that borders a lower portion of the rear window and is upwardly pivotable about an axis extending substantially perpendicularly to a vehicle longitudinal plane on a rear-side end of the rear part.

21. A vehicle according to claim 20, further comprising:
two front seats, the forward roof part substantially covering the two front seats when the forward roof part is attached to the roof structure, and
a rear bench or rear seats arranged and constructed to be folded down or removed to permit the rear roof part to be displaced towards a front of the vehicle, the rear roof part being arranged and constructed to cover the rear bench or rear seats when the rear roof part is disposed in a rearward position on the displacement path.

22. A vehicle according to claim 21, wherein the rear roof part is arranged and constructed to be pivotable into a receptacle defined in the vehicle when the rear roof part is disposed in a forward position on the displacement path.

23. A vehicle according to claim 22, wherein the rear window is upwardly pivotable about an axis that extends substantially perpendicular to the vehicle longitudinal plane.

24. A vehicle according to claim 23, wherein the forward roof part, as well as the rear window, the rear pillars and the rear segment of the rear roof part, are rigid structures.

25. A vehicle according to claim 24, wherein the vehicle further comprises at least one side window in disposed in at least one of a driver's side door and a passenger's side door, wherein contours of the rear pillars that face towards a front of the vehicle and contours of the rear segment that face towards a side of the vehicle respectively correspond to upper and rear contours of the side window.

26. A vehicle according to claim 26, wherein the rear, side elements each comprise a transparent, removable panel.

27. A vehicle, comprising:
a chassis,
a windshield frame supported by the chassis, and
a modifiable roof structure comprising:
a rear roof part displaceable in a longitudinal direction of the vehicle along a displacement path on the chassis, the rear roof part having:
a rear window,
a frame supporting the rear window, and
a rear segment coupled to the rear window and the frame,
a forward roof part removably attachable between the windshield frame and the rear segment when the rear roof part is disposed in a rearward position on the displacement path, the forward roof part having a length in the vehicle longitudinal direction that substantially corresponds to the length of the displacement path of the rear roof part, and
side panels removably attachable adjacent to the frame, the rear segment and the forward roof part when the rear roof part is disposed in the rearward position on the displacement path, the side elements having a length in the vehicle longitudinal direction that substantially corresponds to the length of the displacement path of the rear roof part.

28. A vehicle as in claim 27, wherein, when the forward roof part and side panels are removed from the modifiable roof structure, the rear roof part is displaceable to a forward position on the displacement path, in which forward position the rear roof part at least partially covers a front vehicle seat and the rear segment is disposed adjacent to the windshield frame.

29. A vehicle as in claim 28, wherein a forward edge of the side panels and a forward edge of the frame have contours that conform to a rearward edge of vehicle side windows respectively supported by a driver's side door and a passenger's side door.
